(19) United States
(12) Patent Application Publication
(10) Pub. No.: US 2023/0258077 A1
(43) Pub. Date: Aug. 17, 2023

(54) SYNTHESIZING PROPERTIES RELATED TO WELLBORE STABILITY

(71) Applicants: Barry F. ZHANG, Houston, TX (US); Orlando DE JESUS, Frisco, TX (US); Muhlis UNALDI, Houston, TX (US); Matthew James REILLY, Houston,, TX (US)

(72) Inventors: Barry F. ZHANG, Houston, TX (US); Orlando DE JESUS, Frisco, TX (US); Muhlis UNALDI, Houston, TX (US); Matthew James REILLY, Houston,, TX (US)

(73) Assignees: QUANTICO ENERGY SOLUTIONS LLC; Hess Corporation, Houston, TX (US)

(21) Appl. No.: 17/650,907

(22) Filed: Feb. 14, 2022

(51) Int. Cl. E21B 49/00; E21B 44/00

(52) U.S. Cl. CPC E21B 49/003; E21B 44/00; E21B 2200/22

(57) ABSTRACT

The present disclosure generally relates to synthesizing one or more properties for optimizing one or more operations in a well. Embodiments include receiving measurements or qualitative indicators of one or more parameters in association with performing operations in the well. Embodiments include providing, based on the measurements, one or more inputs to a machine learning algorithm (MLA) that has been trained using historical or training well data. Embodiments include determining, based on one or more outputs from the MLA, one or more synthesized properties relating to the well, wherein the one or more synthesized properties comprise a synthesized pore-pressure at, near, or ahead of a bit position. Embodiments include determining, based on the one or more synthesized properties, one or more optimized parameters relating to at least one of: drilling the well; steering the well; or stimulating a reservoir.

### BACKGROUND OF THE DISCLOSURE

### Field of the Disclosure

The present disclosure generally relates to synthesizing pore pressure, wellbore stability, and/or other parameters, both in real-time and/or after the drilling of a well or a section of a well, such as for optimization of operations including drilling a well and/or stimulation of a reservoir.

### Description of the Related Art

In some cases, real-time adjustments such as to mud properties and drilling parameters (pump rates, RPM, WOB etc) and/or the determination of casing points may be made as part of the process of drilling a well, such as based on measurements and/or observations associated with drilling. Two of the most important factors interpreted in association with drilling are ‘pore pressure’ and ‘wellbore stability’. Pore Pressure is the pressure (force per unit area) of the fluid contained in the pore space of the formation. Wellbore stability (WBS) describes the structural integrity of the wellbore that prevents it from collapsing.

If a well is drilled with a downhole effective mud weight that is at or below the formation pore pressure, the fluid from the formation can enter the wellbore causing a range of issues from wellbore instability to a ‘blowout’ (where formation fluid reaches the surface). Conversely if the pressure in the wellbore is excessively high the drilling fluid can exceed the in situ stress and tensile strength of the rock, causing a fracture. A fracture in the formation can also cause a loss of drilling fluids into the formation, thereby potentially dropping the pressure in other portions of the well bore and causing an influx. After drilling has been completed, and the well may be stimulated to extract the hydrocarbons, the initiation of a fracture into a reservoir in some cases is the desired result. However without knowing the stress, fracture gradient, or pore pressure of the formation, the fracture design may be suboptimal. Higher pore pressures than necessary can also lead to slower drilling (thus increasing expense and risk) or in some cases damage the productivity of the reservoir. Wellbore stability is highly dependent on the interaction between formation pore pressure and the pressure of the drilling fluid (Effective Mud Weight). If the pore pressure and the mud weight are not balanced a force is applied to the wellbore. The greater that force becomes the higher the likelihood of wellbore instability. A difference in temperature between the drilling mud and the formation can also cause wellbore stability, but is primarily measured and determined to ensure human safety on the rig and to prevent downhole sensors from failing.

Traditional pore pressure calculation in association with drilling utilizes a combination of data sources (such as resistivity, sonic, density tools), some of which are detected from sensors placed over one hundred feet behind the drill bit. Furthermore, smoothing algorithms are often used to average the detection data thus increasing the offset from the drill bit to the estimated pore pressure calculation. The result of this is that the pore pressure calculation is only relevant to the formation that has already been penetrated and not the formation that is actively being drilled. In hole sections where minor pore pressure changes can have a significant impact on operational decisions, this delayed measurement has significant disadvantages and risks. Multiple sources of sensory data (such as drilling parameters, etc) are being received in association with drilling a well, and yet many of these sources are typically left unused in pore pressure calculation. As such, there is a need for improved techniques of determining these critical factors that affect drilling, cementing, steering, and reservoir stimulation in both real-time and/or after the drilling of a well or a section of a well. Additionally, there is a need in the art to determine pore pressure closer to the bit, at the bit, or ahead of the bit position in order to optimize drilling operations.

Known equations for estimating pore pressure are based on decades-old laboratory studies involving materials with particular properties, and do not always translate accurately to different materials having different properties. Conventional methods mostly rely on the creation of a standard trend and then comparing the observed data to that of the trend. The definition of this standard trend is subject to interpretation, often requiring highly specialized expertise, and can be a significant source of error. As previously mentioned, these techniques require data from sensors that are placed hundreds of feet behind the drill bit, and so are not able to measure pressure at the bit itself. Additionally, these techniques do not generally provide results quickly or accurately enough to reliably determine pore pressure at, near, or ahead of the bit position, as they involve multiple steps and rely upon highly generalized principles, and may require adjustment by professionals with highly specialized expertise in pore pressure interpretation. For example, one technique for estimating pore pressure at the drill bit involves estimating pore pressure using empirically derived trends of drilling parameters, such as ‘the D-exponent’. However the D-exponent has limited accuracy and may not accurately reflect the interaction on modern drilling rigs between the drill bit and the forces to drill through rock. Furthermore, applying a formula that is a tool for estimation to a value that is itself estimated (e.g., resistivity and/or sonic velocity synthesized using machine learning techniques) involves two layers of estimation, thus introducing a considerable chance for error. If relying on measured parameters as inputs to an estimation equation, the expenses and risks associated with operating the appropriate measurement equipment are incurred.

### SUMMARY OF THE DISCLOSURE

The present disclosure generally relates to synthesizing one or more properties, such as in association with drilling in a well. In one embodiment, a method includes: receiving measurements or qualitative indicators of one or more parameters in association with performing operations in the well; providing, based on the measurements, one or more inputs to a machine learning algorithm (MLA) that has been trained using historical or training well data comprising historical measured values or historical qualitative indicators corresponding to the one or more parameters associated with labels that are based on historical measured values or historical qualitative pore pressure indicators; determining, based on one or more outputs from the MLA in response to the one or more inputs, one or more synthesized properties relating to the well, wherein the one or more synthesized properties comprise a synthesized pore-pressure at, near, or ahead of a bit position; and determining, based on the one or more synthesized properties, one or more optimized parameters relating to at least one of: drilling the well; steering the well; or stimulating a reservoir.

In another embodiment, a system comprises one or more processors and a memory storing instructions that, when executed by the one or more processors, cause the system to: receive measurements or qualitative indicators of one or more parameters in association with performing operations in the well; provide, based on the measurements, one or more inputs to a machine learning algorithm (MLA) that has been trained using historical or training well data comprising historical measured values or historical qualitative indicators corresponding to the one or more parameters associated with labels that are based on historical measured values or historical qualitative pore pressure indicators; determine, based on one or more outputs from the MLA in response to the one or more inputs, one or more synthesized properties relating to the well, wherein the one or more synthesized properties comprise a synthesized pore-pressure at, near, or ahead of a bit position; and determine, based on the one or more synthesized properties, one or more optimized parameters relating to at least one of: drilling the well; steering the well; or stimulating a reservoir.

In another embodiment, a non-transitory computer readable medium stores instructions that, when executed by one or more processors of a computing system, cause the computing system to: receive measurements or qualitative indicators of one or more parameters in association with performing operations in the well; provide, based on the measurements, one or more inputs to a machine learning algorithm (MLA) that has been trained using historical or training well data comprising historical measured values or historical qualitative indicators corresponding to the one or more parameters associated with labels that are based on historical measured values or historical qualitative pore pressure indicators; determine, based on one or more outputs from the MLA in response to the one or more inputs, one or more synthesized properties relating to the well, wherein the one or more synthesized properties comprise a synthesized pore-pressure at, near, or ahead of a bit position; and determine, based on the one or more synthesized properties, one or more optimized parameters relating to at least one of: drilling the well; steering the well; or stimulating a reservoir.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates example operations related to synthesizing one or more properties for optimizing one or more operations in a well, according to embodiments of the present disclosure.

FIG. 2 illustrates an example exchange of messages between components related to synthesizing one or more properties for optimizing one or more operations in a well, according to embodiments of the present disclosure.

FIG. 3 illustrates an example of a computing system with which embodiments of the present disclosure may be implemented.

### DETAILED DESCRIPTION

Embodiments of the present disclosure relate to synthesizing, in both real-time and/or after the drilling of a well or a section of a well, parameters such as pore pressure and wellbore stability for optimized drilling or reservoir stimulation operations. For example, a neural network comprising machine learning algorithms (MLA) may be trained using historical measurements and/or qualitative indicators captured during, before, and/or after past drilling, steering, and/or stimulation operations and/or exploratory measurements taken in connection with exploratory operations, and the neural network may be used to synthesize certain parameters in real-time and/or after drilling a well based on measurements and/or qualitative indicators determined before, during, and/or after performing operations such as drilling a well and/or stimulating a reservoir. Training of neural networks for synthesizing density, porosity, and sonic velocity is described in U.S. Pat. No. 10,677,052, the contents of which are incorporated herein by reference in their entirety.

A neural network (e.g., based on MLA, as described herein) generally uses multiple inputs from different sensors to generate one or multiple outputs. In some embodiments, the inputs can be taken at the same or different depths (or times) of the outputs to be simulated. In an example, the individual inputs (e.g., p₁, p₂, . . . , p_{R}) are weighted by the corresponding elements (e.g., w_{1,1}, w_{1,2}, . . . , w_{1,R}) of the weight matrix W. Each neuron has a bias b, which is summed with the weighted inputs to form the net input n=Wp+b. The net input n is then applied to a transfer function ƒ. The transfer function can be a linear or nonlinear function of n. A particular transfer function is selected based on the problem to solve. Typical transfer functions are linear, hard limit, hyperbolic Tangent Sigmoid (tan sig), Log-Sigmoid (log sig) or Competitive functions. The output of a neuron a can be defined as a=ƒ(Wp+b).

A single-layer network of S neurons may operate over a vector of inputs p to generate an output a, while a combination of layers will create a multilayer neural network. A layer whose output is the network output is the output layer. The other layers are called hidden layers. After the architecture is defined, the next step is training the multilayer neural network. The preferred training method is called backpropagation, which is a generalization of the Least Mean Square error or LMS algorithm. Backpropagation is an approximate steepest descent algorithm, in which the performance index is mean square error. The general steps are: propagate the inputs forward to the network, then calculate the sensitivities backward through the network and use the sensitivities to update the weights and biases using a steepest descent rule. The process is repeated until the objective function is minimized, a number of iterations is executed or the error of an alternate set of data increases after a few iterations.

Neural networks are a technology well-suited to finding the non-linear correlations that exist among large data sets. Neural networks have been applied in certain contexts related to oil and gas exploration, including litho-faces analysis, detection of microseismic events, seismic inversion, and the like.

In the present solution, inputs used to train a machine learning model such as a neural network may include a wide variety of information types, including bit size, ROP, WOB, torque, stand pipe pressure, differential pressure, cuttings data, flow rate, equivalent circulation density, downhole survey data, seismic volumes (both pre- and post-stack), seismic geologic maps, seismic images, electromagnetic volumes, checkshots, gravity volumes, horizons, synthetic log data, well logs, mud logs, gas logs, rock or fluid samples, drilling dynamics data, initial information from wells, core data, gamma, temperature, torque, mud weight, downhole accelerometer data, downhole vibration data, and combinations thereof. In certain embodiments, inputs may include gamma, resistivity, neutron, density, compressional, and/or shear logs as well as pore pressure estimations as calculated from the known equations, such as D-exponent and/or Eaton's method, or adjusted pore pressure estimations after interpretation by a geologist or pore pressure expert. In certain embodiments, attributes from different depth points are used as training data along with adjacent waveforms from a plurality of directions (e.g., above, below, to the sides such as left and right, forward, and/or backward) with respect to each depth point. High-resolution earth modeling is described in more detail in U.S. patent application Ser. No. 17/002,161, the contents of which are incorporated herein by reference in their entirety.

In general, machine learning models, such as neural networks, use weighting values in order to adjust a relative contribution of each input variable to the overall model. Mathematically speaking, each weighting value is a coefficient in the equation being resolved (objective function). In other words, each weighting value applies a unique scaling factor to its respective input variable in the objective function.

Supervised training methods generally involve providing training inputs to a model, comparing outputs of the model to labels that have been assigned to the training inputs, and iteratively adjusting parameters of the model until the outputs match the labels. Labels correspond to parameters that are output by the model, and represent actual “known” values for these parameters for a given set of training inputs. For example, labels may be assigned to a given set of training inputs based on a correlation between the given set of training inputs and a particular value for a parameter that was measured or determined in association with the time the training inputs were measured or determined. Parameters output by the model may include, for example, pore pressure, fracture gradient, compressive strength, formation pressure, rock stress, wellbore stability, Young's modulus and Poisson's ratio, mud weights, and/or the like. The parameters output by the model may also include alerts that warn the driller of certain events such as increased risk for a blowout, the need to increase or decrease the mud weight, and/or the like. In some embodiments, rather than being output directly by the model, alerts may be determined based on outputs from the model. For example, synthesized values output by the model may be compared to one or more rules (e.g., indicating thresholds, patterns, and/or the like) in order to determine whether to generate an alert. Alerts, whether output directly from the model or determined based on outputs from the model, may be provided to one or more individuals (e.g., an operator) so that action may be taken based on the alerts. For example, if an alert indicates that the mud weight is too low and needs to be increased to avoid a blowout, an operator may increase the mud weight based on the alert to avoid the blowout. Examples of alerts that may be generated based on outputs from the model (e.g., either directly or indirectly) include a risk of a blowout, a risk of a stuck pipe, a risk of damaging a drill bit, a risk of a drilling abnormality or a drilling inefficiency, a recommended change in mud weight, a recommended change in rate of penetration (ROP), a recommended change in weight on bit (WOB), and a recommended depth for setting casing.

Pore pressure values used as labels for training data may be based on direct measurements (e.g., from fluid samples extracted from one or more points in a formation) and/or may be derived from other data. Drilling events (kicks, losses, connection gasses, high gas events, and the like) in offset wells can provide quantitative calibration for pore pressure. In a similar way that direct pressure samples (e.g., from fluid extracted from rock) can measure pressure; drilling events can provide (albeit unplanned) quantitative data as to the formation pressure and formation fracture gradient. Certain techniques involve using drilling event data in offset wells and in real time (in the drilling well) to provide pore pressure and fracture gradient measurements (e.g., for use as labels in training data). Reports or annotations from onsite personnel (typically mud loggers or well site geologists) can also provide qualitative data as to formation pressure or fracture gradient. This may be in the form of cuttings descriptions or occurrence of cavings (large pieces of the wellbore that are washed up the hole). Certain techniques involve using this type of qualitative event data in offset wells and in real time (in the drilling well) to provide pore pressure and fracture gradient measurements (e.g., for use as labels in training data). In some cases, derivations of pore pressure that are based on drilling events, reports, annotations, and/or the like, are referred to as “qualitative indicators” of pore pressure, and are used (e.g., in addition to or instead of direct measurements) in determining labels for training data.

In certain examples, training inputs that are labeled with a historical determined pore pressure value, a historical determined wellbore stability value, a historical determined compressive strength value, a historical determined rock stress value, a historical determined formation temperature value, a historical determined Young's modulus value, or a historical determined Poisson's ratio value may include bit size, ROP, WOB, torque, stand pipe pressure, differential pressure, cuttings data, flow rate, equivalent circulation density, downhole survey data, seismic volumes (both pre- and post-stack). It is noted that this list of input parameters is non-limiting, and other input parameters may also or alternatively be used.

In certain embodiments, after a model has been trained, measurements collected by a well operator (e.g., drilling data, gamma, resistivity, neutron, density, compressional, shear, temperature, torque, differential and standpipe pressure, mud weight, fluid pressure, checkshots and/or the like) and, in certain embodiments, parameters derived from measurements and/or other data, are provided as inputs to the model, and synthesized parameters (e.g., pore pressure, wellbore stability, rock stress, formation temperature, compressive strength, Young's modulus and Poisson's ratio, and/or the like) are output by the model in real-time, near real-time, and/or after drilling. Input parameters may be continuously measured and/or determined and provided to the model to produce updated outputs so that the outputs can be used to dynamically adjust operations such as determining mud weight for drilling.

The historical data that is required to develop (train) a model may be obtained in connection with one or more “training wells”, including the measurement of formation properties using subsurface sensors as well as pore pressure estimations as calculated from the known equations, such as D-exponent and/or Eaton's method, or adjusted pore pressure estimations after interpretation by a geologist or pore pressure expert. Measurements of one or more input data parameters (e.g., parameters measured at the surface and/or using one or more non-nuclear and/or passive nuclear tools) and one or more output data parameters may be made in training wells and used to train the MLA. In some cases, historical data used to train a model includes measurements taken with respect to samples from a training well, such as pore pressure measurements from fluid samples extracted from rock.

The well(s) in which the current solution is applied to optimize drilling is/are generally referred to herein as the “target well(s)”. In a target well, one or more parameters are measured and/or determined and provided as inputs into the model to derive one or more synthetic output parameters describing properties of the rock at, near, and/or ahead of the position of the bit, without requiring measurement of the output parameter(s) in the target well(s). In one embodiment, the input data set is comprised of one or more measurements of drilling parameters made on the surface at the drilling rig, avoiding the need for sensors or measurements to be deployed in the wellbore. In another embodiment, subsurface survey data may be added to the input data set. In another embodiment, subsurface measurement of natural gamma radiation may be added to the input data set. In another embodiment, one or more of drilling data, resistivity, sonic velocity, and/or the like may be measured and used as an input to the MLA for synthesizing pore pressure.

In an example embodiment, a machine learning model is trained using labeled training data. For example, training data may include measurements of various parameters (e.g., drilling data, resistivity, sonic velocity, gamma, and/or the like) associated with labels indicating measured/determined values that correspond to output parameters of the model (e.g., pore pressure, compressive strength, or other parameters). For the purposes of generating labels for training data, pore pressure may be determined from formation pressure measurements (e.g., based on fluid extracted from one or more points in the formation) and/or may be based on qualitative indicators (e.g., increasing or decreasing size or shape of drill cuttings, detection of gas in drilling fluids, and/or the like) and/or industry knowledge of professionals associated with operations in training wells. Once trained, the model may be used to synthesize pore pressure (and/or other parameters such as wellbore stability, rock stress, formation temperature, compressive strength, Poisson's ratio, Young's modulus, and/or the like) of a target well at, near, or ahead of the bit position in real-time or near real-time (or after drilling) by providing inputs to the model based on data measured from the target well (e.g., drilling data, resistivity, sonic velocity, gamma, and/or the like) and receiving outputs from the model, based on the inputs, indicating synthesized pore pressure values (and/or other synthesized values, as appropriate). In some embodiments, pore pressure is synthesized based only on drilling data so that the synthesized values can be generated more quickly or closer to the drill bit (e.g., without the need to rely on gamma measurements and the like).

Whereas traditional methods give an estimate of pore pressure after the well has already experienced a change in pressure, techniques described herein can synthesize pore pressure at, near, and/or ahead of the bit position, and as or even before the change is experienced. As such, embodiments of the present disclosure provide faster results as compared to conventional methods of determining pore pressure, and thus can be used earlier in the drilling process to take action based on the synthesized pore pressure.

Notably, according to techniques described herein, pore pressure can be synthesized accurately in real-time ahead of the bit position. Compared to deterministic methods of estimating pore pressure using equations derived from decades-old laboratory studies, machine learning techniques described herein are based on more accurate data determined from training wells similar to the target wells for which pore pressure is synthesized, and therefore produce more accurate synthesized values than those produced by conventional deterministic methods, consequently improving functionality and safety of operations related to drilling.

While deterministic equation methods may capture large trends, machine learning techniques described herein involve capturing a potentially large number (e.g., thousands) of samples from training wells and relying on that data while drilling, based on similarities in other measured parameters, to provide more accurate granular synthesized values. The drilling data provides particularly useful insight for synthesizing pore pressure because drilling data will vary significantly in different wells (e.g., high-pressure regimes versus low-pressure regimes). Thus, the drill bit is able to be utilized as an implicit sensor, with data captured via the drill bit (and, in some embodiments, other measured and/or derived data) being used to provide inputs to a predictive model that outputs accurate reliable synthesized pore pressure values (e.g., in real-time). Synthesized pore pressure values may then be used to adjust parameters related to operations in the target well in real-time, such as adjusting mud weight values to improve drilling. Furthermore, synthesized pore pressure values may further be utilized to derive additional parameters according to known relationships and/or formulas, such as deriving high and/or low cases, confidence intervals, fracture gradients, and/or the like. While certain advantages are described in particular with respect to pore pressure, it is noted that various similar benefits are also achieved when synthesizing other parameters such as compressive strength, Young's modulus, and Poisson's ratio. For example, synthesized compressive strength values may be used in making determinations with regard to setting casing.

The ability to synthesize certain parameters at, near, or ahead of the bit position in real-time, such as pore pressure, allows for a more holistic understanding of factors affecting the drilling process, and thereby allows for intelligent adjustments to be made to drilling parameters in real-time.

In some embodiments, one or more mechanical properties synthesized in real-time in a target well as described herein may be used to optimize steering parameters. As used herein, steering may refer to geosteering. Geosteering generally involves interactive geological placement of a precise (e.g., high angle) well path within a formation by using Inclination and azimuthal measurements. Geological placement may be beneficial (e.g., as opposed to geometric placement) because of the uncertainty regarding positions of targets within a well that may result from the unpredictability of variations (e.g., structural and/or stratigraphic) that may occur in a well. Geosteering may, in some instance, involve comparing real-time LWD data to previously captured data (e.g., from a nearby or similar well) in order to guide a well path to optimum reservoir layers. During a drilling operation, geosteering may involve determining a location of the wellbore relative to pressure changes in the formation. This may be especially relevant where higher formation pressures are a target for completion or fracture stimulation.

Furthermore, synthesized properties may be used to optimize parameters for reservoir stimulation. For example, reservoir initial production rates in unconventional reservoirs have been shown to correlate to higher pore pressures. Therefore a stimulation plan may be generated for a reservoir based on one or more parameters synthesized as described herein. In certain examples, synthesized properties are supplied to a reservoir model in order to generate a stimulation plan for the reservoir. The stimulation plan may be a hydraulic fracturing plan. The fracturing plan may identify a number of production zones and, for each zone, list a setting depth of a fracture plug and a depth of perforation. The fracturing plan may also include a quantity of fracturing fluid to be used for each zone and mixture parameters for the fracturing fluid for each zone. The reservoir model may be implemented on the same computer as the neural network or on a different computer.

It is noted that the terms properties and parameters may, in some instances, be used interchangeably herein.

Techniques described herein constitute improvements with respect to conventional industry practice, as they allow for more targeted adjustments to be made to drilling, steering, and/or stimulation processes in order to optimize certain parameters without requiring slow (or late?), difficult, expensive, and potentially dangerous down-hole measurements (e.g., by avoiding the use of tools with active nuclear sources and/or other tools that are difficult and/or expensive to operate, such as sonic tools). The ability to use computing technology to synthesize certain parameters, such as pore pressure, at, near, or ahead of the bit position in real-time (e.g., while drilling, steering, and/or stimulating), allows for efficiently achieving a greater understanding of the factors affecting the drilling, steering, and/or stimulation processes, and thereby facilitates the use of particular computer-implemented processes for parameter optimization. While conventional practices involve measuring properties at sensor depth, techniques described herein allow for synthesizing properties at, near, or ahead of the bit position, thereby improving precision and timeliness of determinations made based on the properties. For example, synthesizing pore pressure at, near, or ahead of the bit position in real-time allows for precise optimization of parameters affecting drilling such as mud weight. Furthermore, techniques described herein may allow for the reduction of personnel present at a well site, thereby reducing costs as well as health, safety, security and environment (HSSE) risks.

It is noted that, while embodiments are described herein involving both operations for synthesizing properties at, near, or ahead of the bit position in real-time and operations for using the properties to optimize operational parameters in real time, these operations may be performed independently of one another. For example, properties may be synthesized at, near, or ahead of the bit position for purposes other than optimizing operational parameters, and techniques described herein for optimizing operational parameters based on properties at, near, or ahead the bit position may be employed regardless of how the properties are determined.

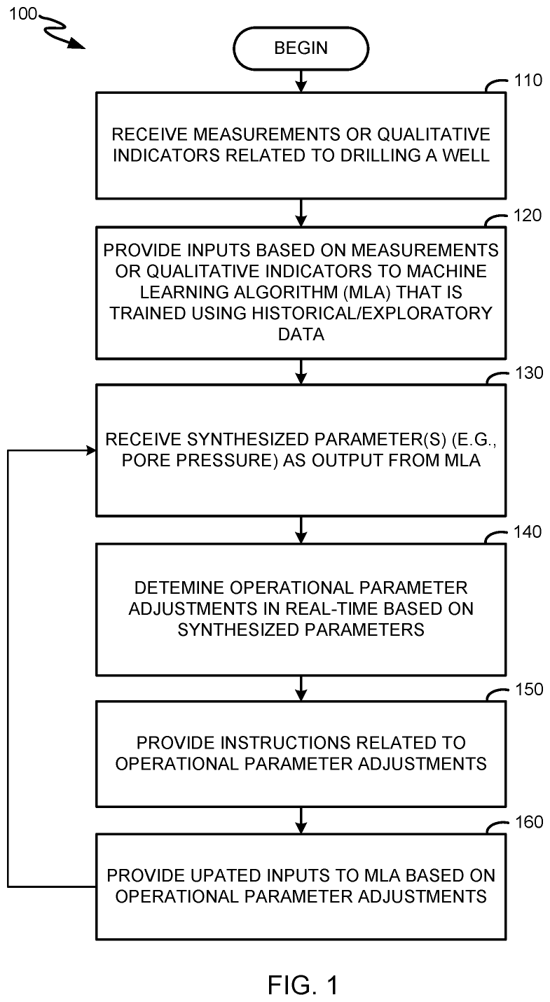

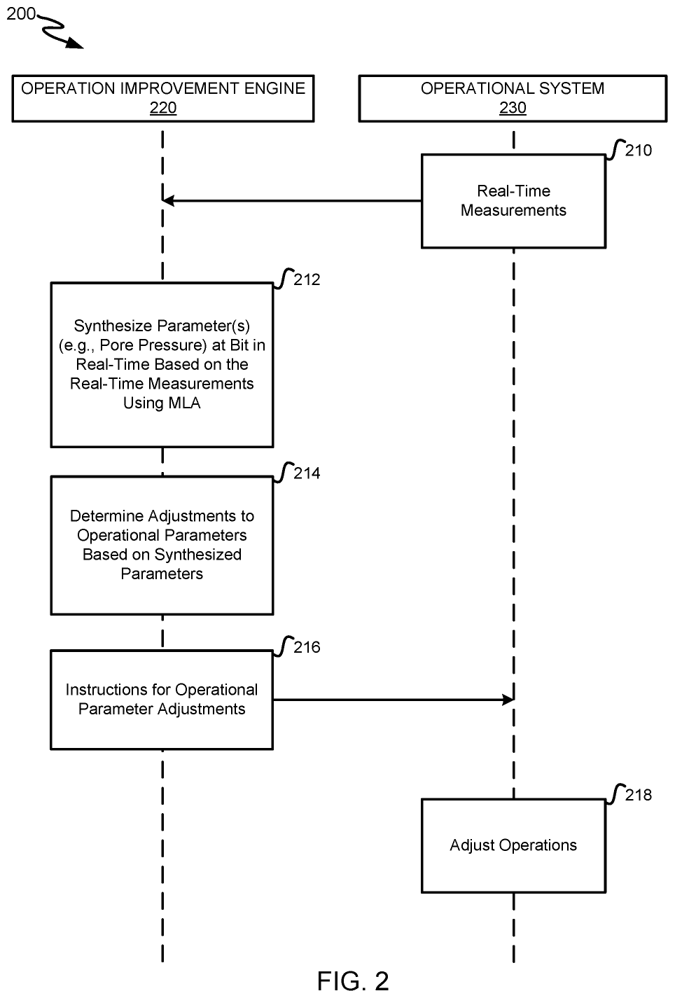

FIG. 1 illustrates example operations 100 related to synthesizing one or more properties for optimized drilling and/or steering a well, and/or stimulation of a reservoir, according to embodiments of the present disclosure. Operations 100 may, for example, be performed by an operation improvement engine (e.g., operation improvement engine 220 of FIG. 2). The operation improvement engine may, for example, be implemented using one or more computing systems including one or more processors and a non-transitory computer readable medium comprising instructions for performing techniques described herein.

Operations 100 begin at step 110, where parameter measurements and/or qualitative indicators are received from an operational system (e.g., a system that performs operations related to drilling, steering, and/or stimulation). The measurements and/or qualitative indicators may, for example, comprise measurements of parameters that were captured using surface-level tools, a drill bit, gamma sondes, and/or the like. Parameters that are measured in real-time may comprise ROP, WOB, torque, LWD, MWD, mud and cuttings analysis, gas detection and analysis, gamma measurements, angles, azimuths, and the like. A qualitative indicator generally refers to data from which a parameter is inferred, such as based on calculation or interpretation by an expert. Parameters measured and/or determined for use in providing inputs to the MLA may, in some embodiments, not include pore pressure, compressional strength, wellbore stability, rock stress, formation temperature, Young's modulus, Poisson's ratio, and/or the like, as one or more of these may be provided as outputs from the MLA.

At step 120, one or more inputs are provided, based on the one or measurements and/or qualitative indicators, to a neural network comprising a machine learning algorithm (MLA) that has been trained using historical and/or training well data according to techniques described herein (e.g., as described above).

At step 130, synthesized parameter(s) are received as output from the MLA. For example, the MLA may synthesize one or more parameters at, near, or ahead of the bit position (e.g., in real-time) based on the measurements and/or qualitative indicators, in view of historical and/or training well data, and/or based on empirical relationships between the measured/determined parameters and the parameters that are synthesized. The synthesized parameters are different than the parameters that were measured and/or determined based on qualitative indicators. For example, the MLA may synthesize pore pressure, compressional strength, wellbore stability, rock stress, formation temperature, Young's modulus, Poisson's ratio, and/or the like at, near, or ahead of the bit position (e.g., in real-time) based on measurements and/or determinations of ROP, WOB, torque, mud and cuttings analysis, gas detection and analysis, natural gamma measurements, angles, azimuths, and/or the like. In some embodiments, step 130 further comprises determining a real-time synthesized position of one or more formation tops relative to a bit location. Furthermore, step 130 may further comprise deriving one or more parameters from one or more synthesized parameters, such as deriving high and/or low cases, confidence intervals, fracture gradients, and/or the like.

In some embodiments, one or more alerts are determined based on the synthesized parameter(s), or one or more alerts are received as outputs from the MLA. An alert may, for example, indicate that a potentially problematic condition exists, and may include a recommended operational parameter adjustment to alleviate the potentially problematic condition.

At step 140, operational parameter adjustments are determined in real-time based on the synthesized parameters. For example, a synthesized pore pressure may be used to determine adjustments to parameters affecting drilling, such as drilling speed, rate of penetration (ROP), weight on bit (WOB), and/or the like, in order to improve drilling, avoid safety risks (e.g., blowouts), reduce costs, and/or the like. In other examples, adjustments to one or more steering parameters (e.g., a steering path) may be determined based on the synthesized parameters. For example, the synthesized parameters may be compared to data from an off-set well in order to determine an optimal steering path through the well. In other examples, a stimulation plan may be determined based on the synthesized parameters. In some embodiments, operational parameter adjustments are determined, at least in part, based on user input. For example, one or more synthesized parameters may be output to a user, such as via a user interface, and the user may provide input indicating one or more operational parameter adjustments. In other embodiments, operational parameter adjustments are determined automatically, such as based on rules and/or machine learning techniques.

At step 150, instructions relating to the operational parameter adjustments are provided to the operational system. Adjustments may then be made at the operational system in accordance with the instructions. For example, a drilling speed may be increased or decreased at the operational system if the instructions comprise an increase or decrease in drilling speed. In another example, a steering path may be updated at the operational system if the instructions comprise an updated steering path. In another example, one or more attributes of a stimulation plan may be updated at the operational system if the instructions comprise updates to the stimulation plan.

At step 160, updated inputs are provided to the MLA based on the operational parameter adjustments, and then operations return to step 130, where updated synthesized parameter(s) are received as output from the MLA. In certain embodiments, the operational system may continue to provide real-time measurements and/or determinations to the operation improvement engine in order to continuously receive updated real-time instructions, advice, and/or information relevant to the operations being performed based on parameters synthesized using the MLA.

In an alternate embodiment, adjustments (e.g., to drilling speed, WOB, and/or the like) may be automatically made in response to determinations by the operation improvement engine. For example, the operation improvement engine may control components of the operational system, and may automatically adjust parameters by controlling components rather than providing instructions for the adjustments to be made.

FIG. 2 illustrates an example message exchange 200 between a operation improvement engine 220 and an operational system 230 related to synthesizing one or more properties for optimized drilling and/or steering a well, and/or stimulation of a reservoir, according to embodiments of the present disclosure.

At 210, operational system 230 sends real-time measurements to operation improvement engine 220. For example, the real-time measurements may comprise survey data that is measured using a measurement while drilling (MWD) system and/or natural gamma data measured using the MWD system. In some embodiments, the real-time measurements do not comprise pore pressure, compressive strength, Young's modulus, or Poisson's ratio measured or determined at, near, or ahead of the bit position.

At 212, operation improvement engine 220 synthesizes properties at, near, or ahead of the bit position in real-time by providing the real-time measurements to the MLA, which may synthesize properties different than the properties measured in real-time. The machine learning model may have been trained using historical or training well data comprising historical measured values corresponding to the one or more parameters associated with labels that are based on historical measured and/or determined (e.g., based on qualitative indicators) pore pressure values, historical measured and/or determined compressive strength values, historical determined Young's modulus values, historical determined Poisson's ratio values, and/or the like. In some cases, rock samples may have been used to determine one or more of the historical values (e.g., Young's modulus, Poisson's raio, and/or the like) used to train the MLA.

The synthesized properties may include, for example, pore pressure, compressive strength, wellbore stability, rock stress, formation temperature, Young's modulus, Poisson's ratio, and/or the like, at, near, or ahead of the bit position.

Certain embodiments further comprise deriving, based on a real-time synthesized pore-pressure at, near, or ahead of a bit position, one or more of: a high case; a low case; a confidence interval; or a fracture gradient.

At 214, operation improvement engine 220 determines adjustments to one or more operational parameters based on the synthesized parameters. In some embodiments, operation improvement engine 220 may develop optimized drilling parameters comprising adjustments to one or more parameters related to drilling. Drilling parameters are only included as one example, and adjustments may alternatively or additionally be determined to one or more steering parameters and/or stimulation parameters. In some embodiments, determining, based on the one or more synthesized properties, the one or more optimized parameters comprises determining a mud weight and/or determining a drilling speed.

At 216, operation improvement engine 220 provides instructions for the operational adjustments to operational system 230.

At 218, operations are adjusted at operational system 230 in accordance with the instructions. The adjustments may, for instance be made automatically by one or more tools of operational system 230, or may, in some instances, be implemented by an engineer. Operational system 230 may continue to take real-time measurements and/or determinations (e.g., based on operational parameter adjustments) and provide the measurements and/or determinations to operation improvement engine 220 in order to continuously receive updated instructions.

In some embodiments, one or more synthesized parameters may be output to a user, such as via a user interface. In some cases no operational parameter adjustments may be made based on synthesized parameters, or operational parameter adjustments may be made separately from the techniques described herein for synthesizing parameters.

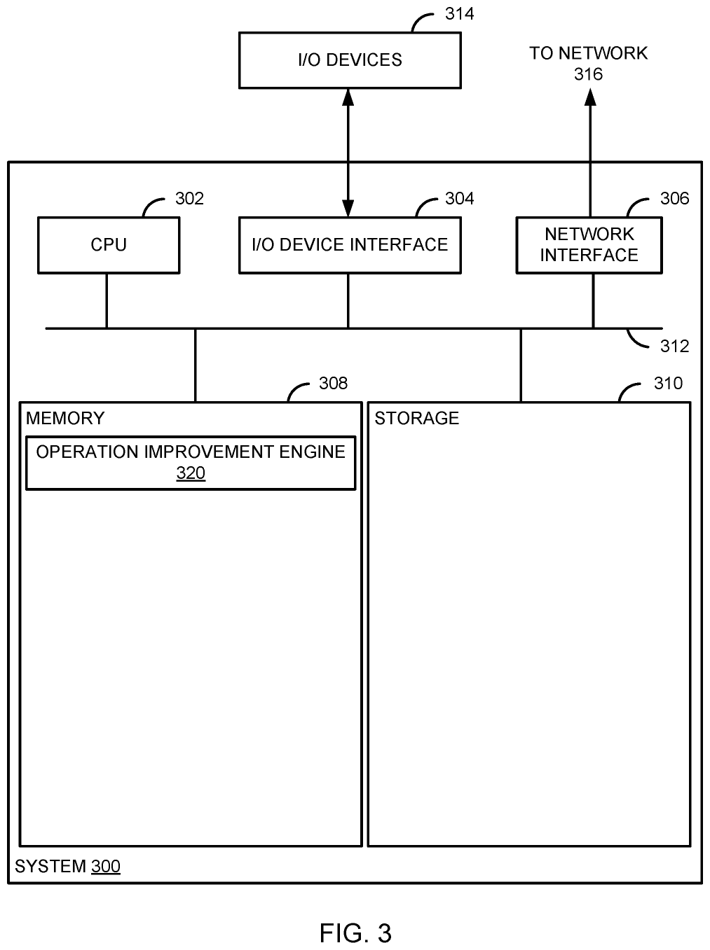

FIG. 3 illustrates an example computer system 300 used for synthesizing one or more properties for optimized drilling and/or steering a well, and/or stimulation of a reservoir, according to embodiments of the present disclosure. As shown, the system 300 includes a central processing unit (CPU) 302, one or more I/O device interfaces 304 that may allow for the connection of various I/O devices 314 (e.g., keyboards, displays, mouse devices, pen input, etc.) to the system 300, network interface 306, a memory 308, storage 310, and an interconnect 312.

CPU 302 may retrieve and execute programming instructions stored in the memory 308. Similarly, the CPU 302 may retrieve and store application data residing in the memory 308. The interconnect 312 transmits programming instructions and application data, among the CPU 302, I/O device interface 304, network interface 306, memory 308, and storage 310. CPU 302 is included to be representative of a single CPU, multiple CPUs, a single CPU having multiple processing cores, and the like. Additionally, the memory 308 is included to be representative of a random access memory. Furthermore, the storage 310 may be a disk drive, solid state drive, or a collection of storage devices distributed across multiple storage systems. Although shown as a single unit, the storage 310 may be a combination of fixed and/or removable storage devices, such as fixed disc drives, removable memory cards or optical storage, network attached storage (NAS), or a storage area-network (SAN).

As shown, memory 308 includes an operation improvement engine 320, which may comprise a neural network that runs a machine learning algorithm (MLA), and may perform operations related to synthesizing one or more properties for drilling, steering, and/or stimulation optimization(e.g., functionality described above with respect to FIGS. 1 and 2). For example, operation improvement engine 320 may receive measurements and/or determinations in real-time from an operational system, and provide inputs to the MLA based on the measurements and/or determinations in order to synthesize one or more parameters (e.g., at, near, or ahead of the bit position, such as in real-time). Operation improvement engine 320 may use the synthesized parameters to provide instructions and information to the operational system (e.g., regarding optimal parameter adjustments), update earth models and seismic maps, and the like. Operation improvement engine 320 in memory 308 may communicate with other devices (e.g., components of an operational system) over a network 316 (e.g., the Internet, a local area network, or the like) through network interface 306 (e.g., in order to receive measurements, provide instructions, and the like).

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method to synthesize one or more properties for optimizing one or more operations in a well, comprising:
receiving measurements or qualitative indicators of one or more parameters in association with performing operations in the well;
providing, based on the measurements, one or more inputs to a machine learning algorithm (MLA) that has been trained using historical or training well data comprising historical measured values or historical qualitative indicators corresponding to the one or more parameters associated with labels that are based on historical measured values or historical qualitative pore pressure indicators;
determining, based on one or more outputs from the MLA in response to the one or more inputs, one or more synthesized properties relating to the well, wherein the one or more synthesized properties comprise a synthesized pore-pressure at, near, or ahead of a bit position; and
determining, based on the one or more synthesized properties, one or more optimized parameters relating to at least one of:
drilling the well;
steering the well; or
stimulating a reservoir.

2. The method of claim 1, wherein the measurements or qualitative indicators comprise one or more of:
drilling data;
a resistivity value;
a gamma value; or
a sonic velocity value.

3. The method of claim 1, further comprising deriving, based on the synthesized pore-pressure at, near or ahead of the bit position, one or more of:
a high case;
a low case;
a confidence interval; or
a fracture gradient.

4. The method of claim 1, wherein determining, based on the one or more synthesized properties, the one or more optimized parameters comprises determining one or more of:
a rate of penetration (ROP);
a weight on bit (WOB);
a mud weight; or
a depth for setting casing.

5. The method of claim 1, wherein:
the labels in the historical or training well data are further based on one or more of:
historical compressive strength values;
historical wellbore stability values;
historical rock stress values;
historical formation temperature values;
historical Young's modulus value; or
historical Poisson's ratio values; and
the one or more synthesized properties further comprise one or more of:
a synthesized compressive strength at, near, or ahead of the bit position;
a synthesized wellbore stability at, near, or ahead of the bit position;
a synthesized rock stress at, near, or ahead of the bit position;
a synthesized formation temperature at, near, or ahead of the bit position
a synthesized Young's modulus at, near, or ahead of the bit position; or
a synthesized Poisson's ratio at, near, or ahead of the bit position.

6. The method of claim 1, further comprising determining, based on the one or more outputs from the MLA, an alert related to a potentially problematic condition related to the operations in the well.

7. The method of claim 6, wherein the alert indicates one or more of:
a risk of a blowout;
a risk of a stuck pipe;
a risk of damaging a drill bit;
a risk of a drilling abnormality or a drilling inefficiency;
a recommended change in mud weight;
a recommended change in rate of penetration (ROP);
a recommended change in weight on bit (WOB); or
a recommended depth for setting casing.

8. The method of claim 1, further comprising:
providing one or more additional inputs to the MLA based on the one or more optimized parameters; and
determining, based on one or more additional outputs received from the MLA in response to the one or more additional inputs, one or more updated synthesized properties relating to the well.

9. A system, comprising:
one or more processors; and
a memory comprising instructions that, when executed by the one or more processors, cause the system to:
receive measurements or qualitative indicators of one or more parameters in association with performing operations in the well;
provide, based on the measurements, one or more inputs to a machine learning algorithm (MLA) that has been trained using historical or training well data comprising historical measured values or historical qualitative indicators corresponding to the one or more parameters associated with labels that are based on historical measured values or historical qualitative pore pressure indicators;
determine, based on one or more outputs from the MLA in response to the one or more inputs, one or more synthesized properties relating to the well, wherein the one or more synthesized properties comprise a synthesized pore-pressure at, near, or ahead of a bit position; and
determine, based on the one or more synthesized properties, one or more optimized parameters relating to at least one of:
drilling the well;
steering the well; or
stimulating a reservoir.

10. The system of claim 9, wherein the measurements or qualitative indicators comprise one or more of:
drilling data;
a resistivity value;
a gamma value; or
a sonic velocity value.

11. The system of claim 9, wherein the instructions, when executed by the one or more processors, further cause the system to derive, based on the synthesized pore-pressure at, near or ahead of the bit position, one or more of:
a high case;
a low case;
a confidence interval; or
a fracture gradient.

12. The system of claim 9, wherein determining, based on the one or more synthesized properties, the one or more optimized parameters comprises determining one or more of:
a rate of penetration (ROP);
a weight on bit (WOB);
a mud weight; or
a depth for setting casing.

13. The system of claim 9, wherein:
the labels in the historical or training well data are further based on one or more of:
historical compressive strength values;
historical wellbore stability values;
historical rock stress values;
historical formation temperature values;
historical Young's modulus value; or
historical Poisson's ratio values; and
the one or more synthesized properties further comprise one or more of:
a synthesized compressive strength at, near, or ahead of the bit position;
a synthesized wellbore stability at, near, or ahead of the bit position;
a synthesized rock stress at, near, or ahead of the bit position;
a synthesized formation temperature at, near, or ahead of the bit position
a synthesized Young's modulus at, near, or ahead of the bit position; or
a synthesized Poisson's ratio at, near, or ahead of the bit position.

14. The system of claim 9, wherein the instructions, when executed by the one or more processors, further cause the system to determine, based on the one or more outputs from the MLA, an alert related to a potentially problematic condition related to the operations in the well.

15. The system of claim 14, wherein the alert indicates one or more of:
a risk of a blowout;
a risk of a stuck pipe;
a risk of damaging a drill bit;
a risk of a drilling abnormality or a drilling inefficiency;
a recommended change in mud weight;
a recommended change in rate of penetration (ROP);
a recommended change in weight on bit (WOB); or
a recommended depth for setting casing.

16. The system of claim 9, wherein the instructions, when executed by the one or more processors, further cause the system to:
provide one or more additional inputs to the MLA based on the one or more optimized parameters; and
determine, based on one or more additional outputs received from the MLA in response to the one or more additional inputs, one or more updated synthesized properties relating to the well.

17. A non-transitory computer-readable medium comprising instructions that, when executed by one or more processors of a computing system, cause the computing system to:
receive measurements or qualitative indicators of one or more parameters in association with performing operations in the well;
provide, based on the measurements, one or more inputs to a machine learning algorithm (MLA) that has been trained using historical or training well data comprising historical measured values or historical qualitative indicators corresponding to the one or more parameters associated with labels that are based on historical measured values or historical qualitative pore pressure indicators;
determine, based on one or more outputs from the MLA in response to the one or more inputs, one or more synthesized properties relating to the well, wherein the one or more synthesized properties comprise a synthesized pore-pressure at, near, or ahead of a bit position; and
determine, based on the one or more synthesized properties, one or more optimized parameters relating to at least one of:
drilling the well;
steering the well; or
stimulating a reservoir.

18. The non-transitory computer-readable medium of claim 17, wherein the measurements or qualitative indicators comprise one or more of:
drilling data;
a resistivity value;
a gamma value; or
a sonic velocity value.

19. The non-transitory computer-readable medium of claim 17, wherein the instructions, when executed by the one or more processors, further cause the computing system to derive, based on the synthesized pore-pressure at, near or ahead of the bit position, one or more of:
a high case;
a low case;
a confidence interval; or
a fracture gradient.

20. The non-transitory computer-readable medium of claim 17, wherein determining, based on the one or more synthesized properties, the one or more optimized parameters comprises determining one or more of:
a rate of penetration (ROP);
a weight on bit (WOB);
a mud weight; or
a depth for setting casing.
